(19) United States
(12) Patent Application Publication
(10) Pub. No.: US 2005/0195507 A1
(43) Pub. Date: Sep. 8, 2005

(54) Specific focus rear-view mirror assembly

(76) Inventor: Sol A. Gonzalvo, Salinas, CA (US)

Correspondence Address: Donald W. Meeker;Patent Agent, 924 East Ocean Front #E, Newport Beach, CA, 92661, US

(21) Appl. No.: 10/791,225

(22) Filed: Mar. 2, 2004

(51) Int. Cl. G02B 5/08; G02B 7/182

(52) U.S. Cl. 359/862; 359/855

(57) ABSTRACT

A narrow rear view mirror is mounted on a ball and socket on a post at an angle to an adhesive base of the mirror. Mating protrusions and indents in the ball and socket lock the mirror in place at a desired angle. Adhering the mirror on an edge of a side mirror of a vehicle enables specific viewing of a driver's blind spot independently of the view of the existing side view mirror. Adhering the mirror to a frame of a computer monitor enables specific viewing of entryways behind the computer user.

### BACKGROUND OF THE INVENTION

1. Field of the Invention

The present invention relates to rearview mirrors and more particularly to a small narrow-angle precision view attachable rear view mirror assembly on a pivotable attachment with locking capability to an angled base, which mounts on an outside vehicle mirror at a different angle from the existing mirror to pick up “blind spots” not visible in the existing mirror or mounts on a computer monitor for viewing people entering a room or cubicle behind a user, the attachable rear view mirror assembly being capable of mounting adjacent to and overlapping an edge of the mirror or on a monitor frame so that it does not interfere with the viewing in the mirror or monitor.

2. Description of the Prior Art

With existing side mirrors on vehicles having a flat surface at a single angle, there is a “blind spot” where a vehicle in an adjacent lane is not visible in the mirror and also not visible in the peripheral vision of the driver. For a passenger vehicle the blind spot occurs usually with the front of the vehicle in the next lane beside the rear of the vehicle of the driver looking in the side mirror. Changing lanes with another vehicle in the blind spot can result in a collision. The problem of “blind spot” vision is particularly critical at high speeds where time is of the essence and any deviation of the driver's view from his path might also result in an accident.

Large curved mirrors which encompass a wide view can catch a wider field of vision to diminish blind spots, but the distortion resulting from such mirrors is confusing and does not distinguish the exact location of the vehicle in the adjacent lane so that it is not clear if the adjacent vehicle is in the dangerous “blind spot” or not.

Prior art add-on rear view mirrors do not adequately provide a clearly distinguishable view of a vehicle which is definitely in the dangerous “blind spot”. Most of the prior art mirrors which are adjustable to a specific angle do not provide an easy-to-use automatic locking means to secure the mirror in the exact position desired. Furthermore, many of the prior art devices are very large and interfere with viewing in the standard side mirror. A similar problem exists with trying to attach most standard mirrors to computer monitors for accurate rear view coverage without covering a portion of the screen.

In addition, protection of information on a computer screen is vitally important to company and personal interests in cases where the information may be used wrongly be someone viewing the computer monitor. The Federal Government now requires new safeguards to protect the privacy of patients health information under HIPAA (Health Insurance Portability and Accountability Act of 1996). The regulation protects medical health information whether it is on paper, in computers or communicated orally. While a health worker works on patients information on the computer, it is required that the health worker makes sure that nobody is standing behind them looking at the patients health information that the worker is processing on the computer. There's already a screen that you can install over your computer monitor but it costs close to $100.00 each. This screen protector blurrs the characters if you are looking from the side of the monitor, so it does not protect direct viewing over the computer operator's shoulder. Prior art privacy rear view mirrors do not adequately provide a precise view of a location where individuals might approach from behind.

U.S. Pat. No. 6,062,699, issued May 16, 2000 to O'Dea, describes a rear view safety mirror that includes two single-planed mirrors mounted at an angle to one another. In the preferred embodiment, the inside mirror is mounted at a steeper pitch than the outside mirror. Preferably, the mirrors are mounted in pockets or slots in a one piece molded plastic housing, wherein the pockets or slots are configured to have the angle. The plastic housing is mounted to the vehicle in a conventional manner, thereby providing the vehicle's operator with familiar adjustment control.

U.S. Pat. No. 6,206,526, issued Mar. 27, 2001 to Hill, illustrates a bifocal plane rear view mirror. The rearview mirror assembly has a primary mirror housing, adapted to be supported on a vehicle. The assembly also has a primary mirror movably supported in the mirror housing. The assembly provides a dependent mirror that has a reflective face, and a back portion, a backing plate, which has a horizontal and a vertical axis, rigidly connected to the back portion, and including a channel extending the length of the vertical axis and centrally located along the horizontal axis, an axle that has a first and a second end movably supported in the channel wherein at least a portion of each end projects outwardly from the backing plate, a means for housing the dependent mirror, and a means for fastening the dependent housing means to the primary mirror.

U.S. Pat. No. 4,200,359, issued Apr. 29, 1980 to Lawson, depicts a small flat mirror that is mounted through use of a wedge-shaped adhesive block to the inside portion of a conventional side view mirror. The block positions the small mirror at an angle of about 15 degrees to 20 degrees with respect to the plane of the side view mirror to thereby eliminate the “blind spot” to the side and the rear of the vehicle.

U.S. Pat. No. 3,180,219, issued Apr. 27, 1965 to Ruiz, provides a split view mirror for automotive or other vehicles, which provides dual vision in two separate sectors accurately adjustable with respect to each other and readily adjustable with respect to the vehicle or other member on which it is mounted.

U.S. Pat. No. D285,188, issued Aug. 19, 1986 to Recht, puts forth the ornamental design for a dual angle rearview mirror.

U.S. Pat. No. 5,033,835, issued Jul. 23, 1991 to Platzer, Jr., is for a remote control mirror with angular viewing adjustments. The mirror structure, for use as a rear view mirror, has a main viewing mirror portion and an auxiliary viewing mirror portion. When the mirror structure is adjusted so that a selected reference portion, of the vehicle which carries the mirror structure, is seen in the auxiliary viewing mirror portion, the main viewing mirror portion is simultaneously positioned to provide an enhanced view of existing traffic. In another form, the mirror is first positioned so that the selected reference portion of the vehicle is viewed therein, and then the mirror is rotated a preselected amount as to present a view further angularly displaced from the vehicle as to thereby provide an enhanced view of existing traffic.

U.S. Pat. No. 6,206,526, issued Mar. 27, 2001 to Hill, illustrates a bifocal plane rear view mirror. The rearview mirror assembly has a primary mirror housing, adapted to be supported on a vehicle. The assembly also has a primary mirror movably supported in the mirror housing. The assembly provides a dependent mirror that has a reflective face, and a back portion, a backing plate, which has a horizontal and a vertical axis, rigidly connected to the back portion, and including a channel extending the length of the vertical axis and centrally located along the horizontal axis, an axle that has a first and a second end movably supported in the channel wherein at least a portion of each end projects outwardly from the backing plate, a means for housing the dependent mirror, and a means for fastening the dependent housing means to the primary mirror.

U.S. Pat. No. 6,522,451, issued Feb. 18, 2003 to Lynam, provides an exterior mirror plano-auxiliary reflective element assembly, which has a plano-multiradius reflective element assembly suitable for use in an exterior sideview mirror assembly mounted to the side body of an automobile. The plano-multiradius reflective element assembly includes a plano reflective element which has a rearward field of view, when mounted in an exterior sideview mirror assembly mounted to the side body of an automobile, with unit magnification. The plano-multiradius reflective element assembly also includes an auxiliary reflective element including a multiradius portion with a rearward field of view. The piano reflective element provides a distortion-free rearward field of view and serves as the principal rearward-viewing portion of the plano-multiradius reflective element assembly. The multiradius portion provides a wide angle rearward field of view, and typically supplements the rearward field of view of the plano portion. The piano reflective element and the multiradius portion are separated by a demarcation element which enables the driver to readily delineate a rearward view in the piano portion from a rearward view in the multiradius portion. The piano reflective element and the multiradius reflective element are individually, separately, and adjacently attached to a single backing plate which is mounted to an actuator of the exterior sideview mirror assembly. By adjusting the position of the backing plate within the housing of the exterior sideview mirror assembly via the actuator, the rearward field of view of both the plano reflective element and the multiradius reflective element are simultaneously and similarly aligned.

U.S. Pat. No. 5,050,977, issued Sep. 24, 1991 to Platzer, Jr., shows an automotive vehicle mirror with a gauging viewing mirror portion. The mirror structure, for use as a rear view mirror, is shown with a main viewing mirror portion and an auxiliary viewing mirror portion. When the mirror structure is adjusted so that a selected reference portion of the vehicle, which carries the mirror structure, is seen in the auxiliary viewing mirror portion, the main viewing mirror portion is simultaneously positioned to provide an enhanced view of existing traffic. In another form, the mirror is first positioned so that the selected reference portion of the vehicle is viewed therein, and then the mirror is rotated a preselected amount as to present a view further angularly displaced from the vehicle as to thereby provide an enhanced view of existing traffic.

U.S. Pat. No. 4,859,046, issued Aug. 22, 1989 to Traynor, claims a lane viewing rear view mirror apparatus for a vehicle, which has a housing adapted to be attached to one side of the vehicle. The mirror assembly is attached to the housing and includes a first planar mirror section that has a reflective surface thereon for visually reflecting to the driver of the vehicle what is in the lane adjacent to the lane that such vehicle is in at a point several car lengths behind such vehicle. A second planar mirror section that has a reflective surface thereon is provided for visually reflecting to the driver of the vehicle what is in the lane directly beside such vehicle, in the blind spot. The second planar mirror section is disposed at an angle with respect to the first planar mirror section. The second planar mirror section is fixed with respect to the first mirror section whereby movement of one mirror section results in a corresponding movement of the other mirror section. A black spacer is disposed between the reflective surfaces of the first and second planar mirror sections for defining a clear line of demarcation to the vehicle operator between what is being shown in each section whereby the user will not become confused, even for an instant.

U.S. Pat. No. D405,745, issued Feb. 16, 1999 to Stirling, discloses the ornamental design for side view mirror.

U.S. Pat. No. D356,537, issued Mar. 21, 1995 to Eisenbraun, indicates the ornamental design for a rear view mirror.

U.S. Pat. No. 5,691,855, issued Nov. 25, 1997 to Lupkas, concerns a wide-angle rear view mirror assembly for a motor vehicle. The assembly has a supplemental optically flat wide angle mirror element mounted in a frame which in turn is mounted on the main rear view mirror assembly of a motor vehicle in juxtaposition with the main frame of the main rear view mirror assembly. The wide-angle rear view mirror assembly is an after market device in one embodiment and is adapted to be mounted directly on the main mirror element of the main rear view mirror assembly, but can also be integrally built into the housing of the main rear view mirror assembly so as to constitute a feature of the automobile as manufactured. Either way, the wide-angle rear view mirror assembly substantially increases the driver's rear view angle of vision utilizing an optically flat mirror, and also has provision for changing the vertical position of the angle of reflection of the wide angle mirror to accommodate different driving circumstances which affect what the driver sees in the wide angle mirror.

What is needed is a small narrow-angle view precision attachable rear view mirror assembly on a pivotable base with an easy-to-use automatic locking capability, which mounts on an outside vehicle mirror at a different angle from the existing mirror to pick up “blind spots” not visible in the existing mirror or mounts on a computer monitor for viewing people entering a room or cubicle behind a user, the attachable rear view mirror assembly being capable of mounting adjacent to and overlapping an edge of the mirror or monitor so that it does not interfere with the viewing in the mirror or monitor.

### SUMMARY OF THE INVENTION

An object of the present invention is to provide a small narrow-angle precision view attachable rear view mirror assembly on a pivotable base with an easy-to-use automatic locking capability, which mounts on an outside vehicle mirror at a different angle from the existing mirror to pick up “blind spots” not visible in the existing mirror or mounts on a computer monitor for viewing specific locations of people entering a room or cubicle behind a user, the attachable rear view mirror assembly being capable of mounting adjacent to and overlapping an edge of the mirror so that it does not interfere with the viewing in the mirror.

A further object of the present invention is to provide a ball-in-socket mount on the narrow focus small rear view mirror which allows for a complete range of motion to be adjustable at a desired angle to focus on a “blind spot” when mounted on a side mirror of a vehicle and focus on a particular spot, such as a doorway, behind a computer user at a monitor.

A related object of the present invention is to provide a ball-in-socket adjustable rear view mirror with indents in the socket surface and mating protrusions in the ball to provide automatic easy-to-use locking of the mirror at any desired angle.

Another object of the present invention is to provide a rear view mirror with a small surface and is adapted for mounting on a frame or an edge of an existing mirror of monitor so that it does not interfere with viewing the image in the existing mirror or monitor.

One more object of the present invention is to provide a rectangular shaped small mirror surface which takes up less mirror or monitor viewing space and blends in with the borders of the mirror or computer monitor.

In brief, a small narrow-angle precision view attachable rear view mirror assembly is mounted on a pivotable base with a ball-in-socket mount which allows for a complete range of motion to be adjustable at a desired angle to focus on a “blind spot” when mounted on a side mirror of a vehicle and focus on a particular spot, such as a doorway, behind a computer user at a monitor. Indents in the socket surface and mating protrusions in the ball provide automatic easy-to-use locking of the mirror at any desired angle.

An angled base enables mounting on an outside vehicle mirror at a different angle from the existing mirror to pick up “blind spots” not visible in the existing mirror or mounts on a computer monitor for viewing directly behind a user. Having a small reflective surface and small base, the attachable rear view mirror assembly is adapted for mounting adjacent to and overlapping an edge or frame of the mirror so that it does not interfere with the viewing in the mirror.

The small rectangular mirror mates with the edges and frames of side mirrors and monitors and enables a wider range of movement than a larger round mirror, the edge of which contacts the existing mirror or monitor surface before the edge of the smaller rectangular mirror of the present invention allowing a wider range of motion for viewing in an exact desired location. A small base with a ball and socket mount also permits a wider range of motion of the mirror since the base does not impede or restrict the angle of movement of the mirror as much as a broader base or other types of mount.

An advantage of the present invention is that it provides a small narrow-angle precision view attachable rear view mirror assembly which focuses on a blind spot on a vehicle mirror and focuses on an entryway behind a computer user.

Another advantage of the present invention is that it provides a pivotable base with an easy-to-use automatic locking capability.

One more advantage of the present invention is that it provides an attachable rear view mirror assembly which does not interfere with the viewing in an existing mirror or monitor.

An additional advantage of the present invention is that it protects the computer monitor user against unexpected surprises from behind specially for office workers who occupy cubicles and whose backs are facing the door.

One more advantage of the present invention is that it protects information, such as protecting patients medical health information, on computer monitors.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a cross-sectional view through 1-1 of FIG. 3 showing the adjustable blind spot rear view mirror of the present invention attached to a standard side mirror of a vehicle;

FIG. 2 is an exploded perspective view of the adjustable blind spot rear view mirror having a pivotable self-locking ball and socket connection on an angled base with indentations on the inside of the socket and mating protrusions on the outside of the ball;

FIG. 3 is a front elevational view through 1-1 of FIG. 3 showing the adjustable blind spot rear view mirror of FIG. 1 attached to a standard side mirror of a vehicle;

FIG. 4 is a front elevational view of a left outside rear view mirror of a vehicle with the adjustable blind spot rear view mirror mounted on a right edge;

FIG. 5 is a front elevational view of a left outside rear view mirror of a vehicle with the adjustable blind spot rear view mirror mounted on a bottom edge;

FIG. 6 is a front elevational view of a right outside rear view mirror of a vehicle with the adjustable blind spot rear view mirror mounted on a left bottom corner edge.

FIG. 7 is a front elevational view of a computer monitor having a number of the adjustable rear view mirrors mounted on a top and sides of the frame;

FIG. 8 is a front elevational view of a computer monitor having an alternate embodiment of the invention with an L-shaped post mounted on a top and two sides of the outside edges of the monitor;

FIG. 9 is a broken perspective view of the alternate embodiment of the invention with a ball from the L-shaped post mount aligned for insertion in the socket of the mirror, showing a plethora of protrusions on the ball and mating indents in the socket.

### BEST MODE FOR CARRYING OUT THE INVENTION

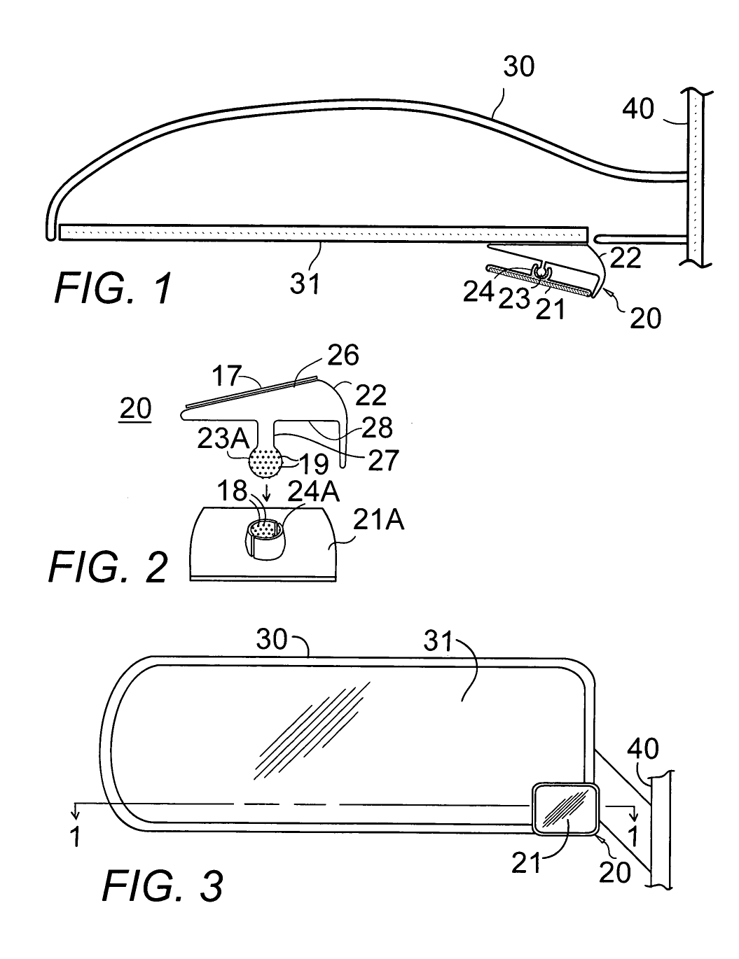

In FIGS. 1-9, a rear view mirror device is a rear view mirror assembly 20 and 20A for pinpointing precise viewing locations behind a user comprises a rear view mirror 21 and 21A pivotally mounted on a base 22 and 22A.

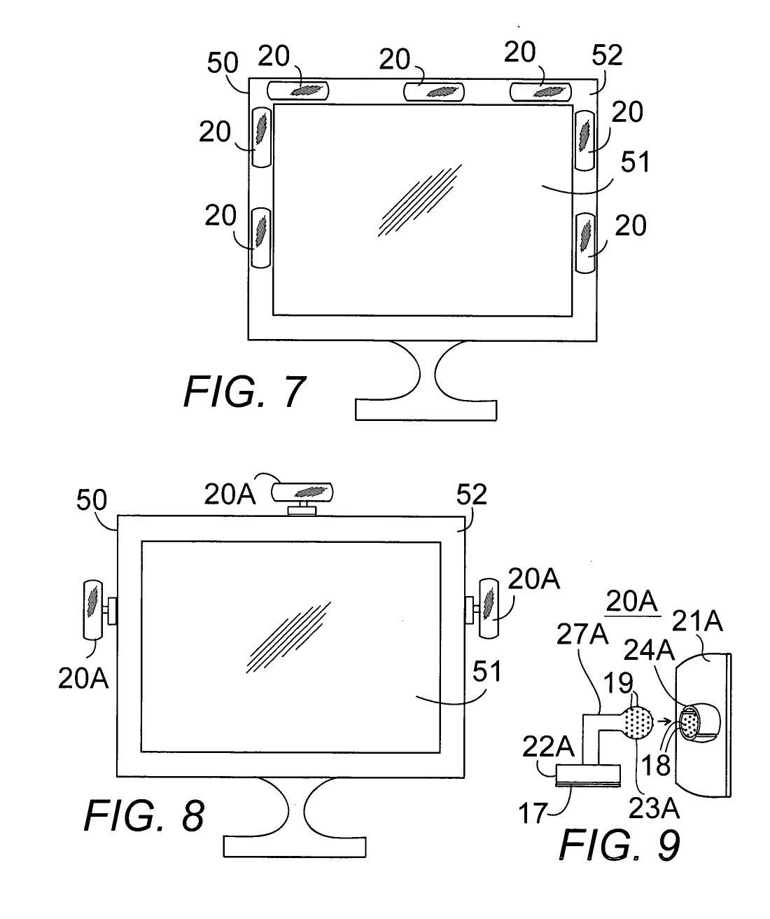

In the preferred embodiment for mounting on vehicle side mirrors of FIGS. 1-6, the rear view mirror assembly 20 comprises a base 22, as shown in FIG. 2, comprising a flat exterior attaching surface 26 covered with an adhesive layer 17, which may have a peel-off covering removed for mounting, an interior mirror mounting surface 28 spaced apart from the attaching surface and structured at an angle to the attaching surface. A post 27 extends orthogonally from the interior mirror mounting surface 28 and a ball 23 and 23A and a socket 24 and 24A form a pivotable connection attaching the mirror 21 and 21A to the base 22. The mirror 21 and 21A comprises a narrow focus mirror preferably rectangular in shape and having a narrow dimension wherein the mirror surface is not greater than two inches in width enabling the reflective viewing of a specific location. The mirror 21 and 21 A is pivotally attached to the ball 23 and 23A and socket 24 and 24A and the post 27 so that the normal perpendicular orientation of the mirror to the post 27 is at an angle to the exterior attaching surface 26 to pick up reflections of specific locations such as the driver's “blind spot” not visible in the side view mirror 30 because of the different angle on a side mirror mount as shown in FIGS. 1 and 3-6, and such as an entryway to a room or a cubicle not visible behind a user of a computer monitor on a computer monitor mount, shown in FIG. 7. The ball and socket connection allows for a full circular range of motion to be adjustable at any desired angle to focus on a precise viewing location.

In FIG. 2, the ball and socket connection preferably comprises a plethora of indents 18 in the socket 24A surface and a plethora of mating protrusions 19 on the ball 23A to provide automatic easy-to-use locking of the mirror at any desired angle with one or more of the protrusions 19 engaging one or more of the indents 18.

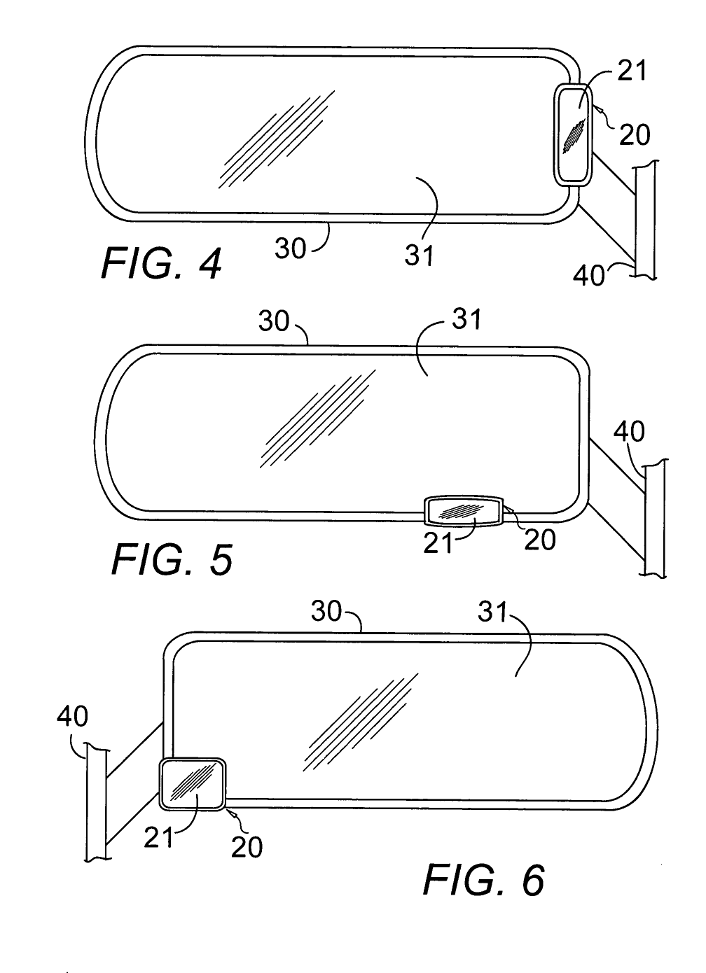

In FIGS. 1 and 3-6, the device is adapted for mounting on the flat reflective surface 31 of a side mirror 30 of a vehicle 40 adjacent to an edge thereof, which is preferably the inside edge on a driver's side mirror, as shown in FIGS. 1, 3, and 4, either in a preferred lower corner, as shown in FIG. 3, or middle of the right edge as shown in FIG. 4. The device 20 may be mounted along a bottom edge as in FIG. 5. On the passenger side mirror, shown in FIG. 6, the device 20 is preferably attached to the lower left corner. The base 22 is adapted to adhere to the reflective surface 31 of the side mirror 30 with the mirror surface 21 of the device extending over an edge of a side mirror for the least interference with viewing through the side mirror 30.

In FIG. 7, the device 20 is adapted for mounting with the base adhered to a frame 52 of a computer monitor 50 preferably along the sides or the top so that the device does not interfere with the viewing in the monitor screen 51.

In FIGS. 8 and 9, a preferred embodiment of the invention for mounting on a computer monitor 50 comprises a flat base 22A with a flat adhesive surface 17 for mounting and an L-shaped post 27A having a ball 23A with a plethora of protrusions 19 aligned to mate with a socket 24A on the mirror 21A, the socket having a plethora of mating indents 18. The L-mounted mirrors 21A extend beyond the edges of the computer monitor.

The mirror surface 21 and 21A may comprise a flat reflective surface or a curved reflective surface as desired.

It is understood that the preceding description is given merely by way of illustration and not in limitation of the invention and that various modifications may be made thereto without departing from the spirit of the invention as claimed.

1. A rear view mirror device for pinpointing precise viewing locations behind a user, the device comprising:
a rear view mirror assembly comprising a base comprising a flat exterior attaching surface covered with an adhesive layer, an interior mirror mounting surface spaced apart from the attaching surface and structured at an angle to the attaching surface, a post and ball and socket connection extending orthogonally from the interior mirror mounting surface a narrow focus mirror pivotally attached to the post and ball and socket connection so that the normal perpendicular orientation of the mirror to the post is at an angle to the exterior attaching surface, the assembly adapted to allow for a full circular range of motion to be adjustable at any desired angle to focus on a precise viewing location.

2. The device of claim 1 wherein the ball and socket connection further comprises a plethora of indents in the socket surface and a plethora of mating protrusions on the ball to provide automatic easy-to-use locking of the mirror at any desired angle.

3. The device of claim 2 wherein the mirror surface is rectangular in shape.

4. The device of claim 2 wherein the mirror surface is not greater than two inches in width.

5. The device of claim 2 wherein the rear view mirror assembly is adapted for mounting on a side mirror of a vehicle adjacent to an edge thereof, the base being adapted to adhere to a surface of a side mirror with the mirror surface of the device extending over an edge of a side mirror, and the precise viewing location is a driver's “blind spot”.

6. The device of claim 2 wherein the mirror assembly is adapted for mounting with the base adhered to a frame of a computer monitor and the precise viewing location is a point of entry behind a computer user in front of the monitor.

7. The device of claim 2 wherein the mirror surface comprises a flat reflective surface.

8. The device of claim 2 wherein the mirror surface comprises a curved reflective surface.

9. The device of claim 2 wherein the post is configured in an L shape.
